(19) United States
(12) Patent Application Publication
(10) Pub. No.: US 2026/0301993 A1
(43) Pub. Date: Oct. 1, 2026

(54) Radial water barrier for a subsea cable

(71) Applicant: NEXANS, Courbevoie (FR)

(72) Inventors: Audun Johanson, Oslo (NO); Øyvind Iversen, Ski (NO); Sigurd Schawlann, Son (NO)

(21) Appl. No.: 19/545,269

(22) Filed: Feb. 20, 2026

(30) Foreign Application Priority Data
Mar. 26, 2025 (NO) 20250334

(51) Int. Cl. H01B 7/282; H01B 7/14; H01B 7/18; H01B 13/10

(52) U.S. Cl. CPC H01B 7/2825; H01B 7/14; H01B 7/18; H01B 13/10

(57) ABSTRACT

A radial water barrier for a subsea cable is proposed, wherein the water barrier comprises a longitudinally welded lead-free metal sheet formed into a tube having an outer surface, wherein at least a part of the outer surface has a radially undulating structure with a pitch of at least 2 mm in a longitudinal direction, and wherein the radially undulating structure has an amplitude in form of a radial depth of the geometric pattern in the range of 0.015 mm to 5 mm.

### CROSS REFERENCE TO RELATED APPLICATION

This application is related to and claims the benefit of Norwegian Patent Application Number 20250334 filed on 26 Mar. 2025, the contents of which are herein incorporated by reference in their entirety.

### Technical Field

The invention relates to a radial water barrier for a subsea cable, a method for manufacturing a subsea cable, and a dynamic high-voltage submarine cable.

### BACKGROUND OF THE INVENTION

Offshore power transmission is an important component in supporting floating platforms and other marine installations, particularly for renewable energy and oil and gas operations. This transmission relies on high-voltage cables typically operating at 11 to 245 kV or even higher. These cables must be designed to endure extreme subsea conditions. A reliable cable system usually consists of both dynamic and static cables, each serving distinct roles in power delivery.

Dynamic cables are often used to provide a connection between a floating platform and a static seabed cable. Their exposure to continuous movement due to platform dynamics necessitates the use of buoyancy elements to manage stress and maintain optimal positioning. The upper segment (0-30 meters below the water line) of the dynamic cable is particularly prone to mechanical loading and fatigue, especially close to the attachment point to the floating platform. Meanwhile, static cables, which rest on the seabed at greater depths, are usually less affected by dynamic mechanical forces The full dynamic cable segment suspended from the floating platform to the static cable is however subjected to extensive mechanical loads—often in combination with external hydrostatic pressure.

Subsea cables often comprise a core with one or more insulated conductors, which are enclosed within a radial water barrier to prevent moisture ingress. In the past, exemplarily static submarine cables have relied on lead sheets as water barriers, posing environmental and health risks.

EP 2 896 053 B1 discloses a radial water barrier for dynamic high-voltage submarine cables used in deep-water applications, preventing moisture ingress into the electrical insulation system. It addresses challenges posed by mechanical fatigue and hydrostatic pressure by providing a specific corrugation design of metal sheets to enhance both flexibility and strength.

### SUMMARY OF THE INVENTION

It is an object of the invention to propose an improved radial water barrier for a dynamic high-voltage submarine cable.

The object is met by a radial water barrier having the features of independent claim 1. Further advantages and additional improvements may be gathered from the dependent claims and the following description.

A radial water barrier for a subsea cable is proposed, wherein the water barrier comprises a longitudinally welded lead-free metal sheet formed into a tube having an outer surface, wherein at least a part of the outer surface has a radially undulating structure with a pitch of at least 2 mm in a longitudinal direction, and wherein the radially undulating structure has an amplitude in the form of a radial depth of the radially undulating structure in the range of 0.015 mm to 5 mm.

The radial water barrier for a subsea cable is designed to prevent water ingress, thereby maintaining the integrity and functionality of the cable in underwater environments. According to the invention, the water barrier is provided using a lead-free metal sheet, which is advantageous for environmental and health reasons. The term “lead-free” in the framework of this invention is to be understood that the content of lead is below 10 wt.-%, preferably below 2 wt.-% based on the total weight of the metal or metal alloy. The metal sheet is supposed to be lead-free because the metal sheet should be made of a metal or metal alloy substituting lead as the material used in the state of the art as water barriers for high-voltage submarine cables.

The term “subsea cable” may be understood as referring to a submarine cable, which may include static submarine cables designed for permanent installation on or beneath the seabed, and dynamic submarine cables optimized for accommodating the movement of floating or mobile offshore platforms. Each cable configuration typically comprises one or more conductive elements, dielectric insulation, electromagnetic shielding, and protective outer layers, with material choices and structural designs tailored to meet specific voltage, current, thermal, and mechanical requirements. For example, the subsea cable may be used at more than 3.000 m under the sea level. The subsea cable may be used under a pressure of more than 0 MPa to 60 MPa, preferably 1 MPa to 40 MPa, more preferred 5 MPa to 30 MPa, most preferred 5 MPa to 25 MPa.

The longitudinally welded metal sheet may be applied over an insulating layer or a semiconductive layer, for example an outer semiconductive layer, of a cable. The metal sheet may provide essential functions such as water tightness, mechanical protection, and the ability to carry fault currents. The selection of materials and design for dynamic cables, particularly those used in high voltage applications with voltages of at least 36 kV, requires special consideration due to the mechanical stress and potential wet conditions they may encounter. The metal sheet is longitudinally welded, meaning that the weld runs along the length of the sheet, forming a continuous seam that ensures the function properties of the sheathing namely water resistance of the barrier. For example, but not limiting the subject-matter of the invention, the metal sheet may be placed in longitudinal direction or helical windings like a tape.

According to the invention, the metal sheet is formed into a tube, providing a cylindrical shape that encases a major part of the components of the subsea cable. The tubular form encapsulates the cable core and prevent water penetrating to the cable core.

The outer surface of the tube comprises a radially undulating structure for improving the mechanical properties of the barrier, such as its flexibility and resistance to excessive deformation. The radially undulating structure may be understood as a radial extension of the outer surface that varies along the axial direction of the cable. The general shape of the outer surface of the tube thus manifests as a wavy structure with undulations that create corrugations or grooves. These undulations result in alternating peaks and valleys, giving the surface a dynamic and textured appearance. The amplitude of these variations, defined by the radial depth, contributes to the shape of the radially undulating structure. The circumferential path of the corrugations or grooves may form a plane that is substantially perpendicular to the axial direction of the cable, such that a series of substantially parallel (and closed-loop) corrugations or grooves may be created. This means that each groove or corrugation completes a full 360-degree turn around the cable without progressing along the axial direction of the cable. The corrugations are thus purely circumferential.

As an alternative, the corrugations or grooves may be formed by one or more corrugations or grooves that helically extend along the axial direction. Thus, the undulation forms a continuous spiral groove or ridge rather than individual, separate, closed-loop corrugations. This means that the undulation does not close upon itself in a single plane but instead progresses along the axial direction of the cable while rotating around the axial direction. Each turn of the undulation gradually shifts along the axial direction rather than remaining confined to a single circumferential position. The angle between the direction of the helical corrugation and the axial direction of the cable may be understood as helical angle. It may be understood as the inclination of the helical corrugation relative to the axial direction of the cable, which is typically define as the angle between the line tangent to the helical path of the groove at any given point and the longitudinal direction of the pipe. The helical angle is less than or greater than 90° since a helical angle of 90° defines the special example with a series of parallel and closed-loop corrugations.

It is not ruled out that the radial water barrier has several sections, in which the pitches and/or amplitudes differ from each other. Providing the radially undulating structure improves the mechanical properties of the water barrier, providing increased flexibility and strength.

The radially undulating structure on the outer surface of the water barrier has a pitch in the longitudinal direction, meaning the pattern repeats at regular or irregular intervals along the length of the tube. This pitch may influence the overall structural behavior of the water barrier, including its ability to withstand external pressures and mechanical impacts. The pitch, which could also be referred to as undulation pitch, may be understood as the distance between two adjacent undulation peaks or two adjacent undulation valleys.

The radially undulating structure also has an amplitude, defined as the radial depth of the pattern, which is in the range of 0.015 mm to 5 mm. The radial depth may be measured as the difference between the smallest and the largest radial extension.

The radial depth as stated herein allows to maintain contact pressure with underlying layers which ensures hydrostatic pressure resistance.

The metal sheet may comprise copper, a copper alloy, aluminium, an aluminium alloy, or steel. Copper is a highly conductive, corrosion-resistant material, and has excellent fatigue resistance, making it suitable for dynamic subsea environments. In addition, copper is easy to weld or solder, which facilitates the process of manufacturing. Copper alloys, such as bronze, brass, or copper-nickel, combine beneficial properties of copper with enhanced mechanical strength, corrosion resistance and enhanced welding properties compared to pure copper. These alloys can be tailored to specific requirements by adjusting their composition. For example, copper alloys may be used when additional strength or specific corrosion resistance is needed. Bronze and copper-nickel alloys are known for their resistance to seawater corrosion. In some embodiments, the use of copper alloys may reduce the overall weight of the cable compared to lead sheathed cable, improving handling and installation. Other exemplary copper alloys may include CuNi, e.g., with 20-40 weight % Ni. Other interesting Cu-based alloys may include CuNiFe, ETP- or oxygen-free copper, or CuNiSi. Aluminium and aluminium alloys have excellent low weight and low permeability to moisture and may thus be advantageous for use in the water barrier in subsea cables. Steel, and particularly stainless steel, e.g., SS316, offers high mechanical strength, excellent corrosion resistance, and durability. Steel sheets offer high tensile strength and impact resistance, as well as high resistance to stress corrosion cracking and pitting. It is understood that each material choice may involve a trade-off between electrical performance, mechanical properties, corrosion resistance, and cost. All of these materials are non-toxic and environmentally friendly, as opposed to lead.

The metal sheet may have a thickness in the range of 0.1 to 0.7 mm. This may be provided in combination with any of the features above. This range allows for an easy formation of the radially undulating structure, achieving a minimum weight and simplifying the manufacturing process. At the same time, sufficient mechanical protection, thermal conductivity, and electrical conductivity can be achieved.

The radially undulating structure may comprise a corrugation. A corrugation may be understood as a series of preferably parallel ridges and grooves formed into a surface, creating a wavy pattern. The ridges and grooves may have a harmonically rounded, continuous, step-free design. Again, this may be provided in combination with any of the features above.

The radially undulating structure may comprise a helical radial protrusion and/or a helical radial indentation. As stated above, the radially undulating structure, i.e., the grooves and ridges, may be formed by a single structure that is helically wound along the axial direction. Again, this may be provided in combination with any of the features above.

In this context, it is to be understood that the term “undulation” is a general term to describe the radial changes in the shape of the radial water barrier, wherein the changes may be regular or irregular. However, the term “corrugation” is a special form of “undulation”, with the radial changes being regular with regularly spaced peaks and valleys.

The longitudinal pitch may be in a range of 5 mm to 150 mm. A lower pitch may improve the flexibility and mechanical properties of the radial water barrier. This pitch range may be provided in combination with any of the features above.

The tube may have an inner diameter of at least 60 mm. Inner diameters exceeding 60 mm may be advantageous, for example 70 mm or more and even 80 mm or more. This inner diameter may be provided in combination with any of the features above.

The radial water barrier may comprise a tape layer having a tape helically wound around an underlying layer of the cable, wherein consecutive tape windings may overlap or may be distanced to each other, and wherein the metal sheet may be arranged in a substantially flush contact on the tape layer. When consecutive tape windings overlap each other, the tape creates a helically stepped outer surface where each winding partially covers the previous one. These steps form a series of helical ridges and ledges along the length of the underlying layer. When the metal sheet is arranged in flush contact on this stepped surface, the sheet will conform to the ridges and ledges, creating an uneven, textured appearance that forms the radially undulating structure. The metal sheet will, for example, have helical raised stripes corresponding to the underlying steps, giving it a ribbed pattern. When consecutive tape windings are arranged with a distance to each other, the tape forms a helical pattern with visible gaps between consecutive windings. These gaps create a discontinuous surface with exposed sections of the underlying layer. When the metal sheet is arranged in flush contact on this surface, it will bridge the gaps between the windings, creating a series of spans and depressions that form the radially undulating structure. The metal sheet will have a wavy, undulating appearance, with smooth sections where it contacts the tape and recessed areas where it spans the gaps. In both cases, the metal sheet will closely follow the contours of the tape layer, resulting in a distinctive surface texture that reflects the underlying winding pattern. The overlapping windings produce a ribbed texture, while the distanced windings create a wavy, undulating surface. The term “substantially flush” is to be understood as predominantly flush, meaning that in some regions gaps between the tape layer and the metal sheet may still exist. However, they preferably exist to a minimum extent. The underlying layer may be a semiconductor or an insulating layer, depending on the setup of the cable. The tape layer having such a structure may be provided in combination with any of the features above.

The tape may be a swelling tape. Such a swelling tape may comprise a water-blocking material used to prevent longitudinal water ingress. It may consist of a non-woven or woven fabric impregnated with superabsorbent polymers (SAPs) that expand upon contact with water, forming a gel-like barrier. This expansion effectively seals voids and interstices within the cable, limiting water propagation along its length. The tape may swell and the metal sheet may follow the shape change and the increasing tape volume.

In an alternative or additionally thereto, the tape may be a textile, rubber, PTFE or metal tape. If the tape is a metal tape, it may be thicker or thinner than the water barrier or it may have the same thickness. Alternatively the tape may be an impregnated tape constituting textile tapes infused with a viscous sealing substance.

The invention further relates to a method for manufacturing a subsea cable, comprising the steps of forming at least one conductor, applying at least one insulation and/or semiconducting layer, and forming a radial water barrier around the at least one insulation and/or semiconducting layer by longitudinally welding a lead-free metal sheet formed into a tube having an outer surface, wherein at least a part of the outer surface has a radially undulating structure with a longitudinal pitch in a longitudinal direction, and wherein the radially undulating structure has an amplitude in form of a radial depth of the radially undulating structure in the range of 0.015 mm to 5 mm.

The method may further comprise the step of forming a tape layer by helically winding a tape around the at least one insulation and/or semiconducting layer, wherein consecutive tape windings may overlap or may be distanced to each other, wherein the metal sheet may be arranged in flush contact on the tape layer, wherein the radial water barrier may be formed on the tape layer, and wherein the radially undulating structure of the radial water barrier may be formed through the tape layer.

As stated above, the longitudinal pitch may be in a range of 5 mm to 150 mm. This may be provided in combination with any of the features above.

The invention further relates to a dynamic high-voltage submarine cable, comprising at least one conductor, at least one insulation and/or semiconducting layer, and a radial water barrier according to the above.

The cable may further comprise an armoring layer, and an outer sheath.

### BRIEF DESCRIPTION OF THE DRAWINGS

In the following description this invention will be further explained by way of exemplary embodiments shown in the drawings:

FIG. 1 shows a subsea cable in a sectional view.

FIG. 2 shows a sectional view of the cable of FIG. 1.

### DETAILED DESCRIPTION OF EXEMPLARY EMBODIMENT

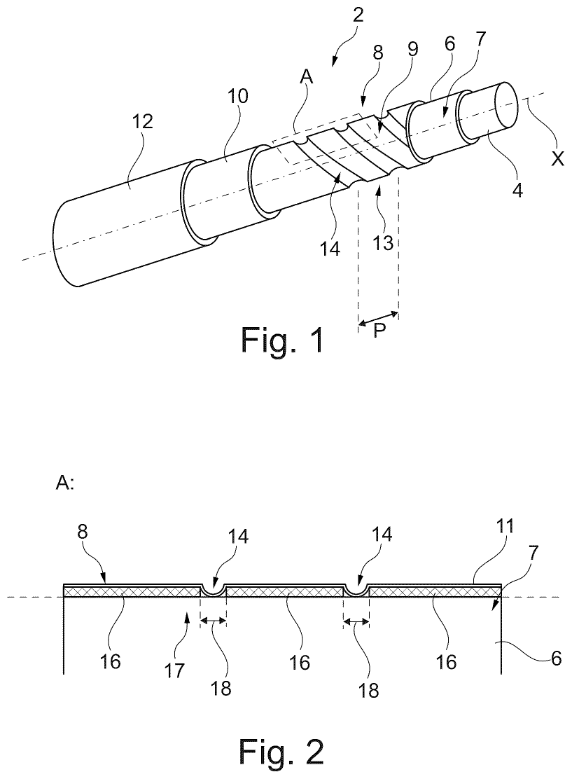

FIG. 1 illustrates a subsea cable 2, specifically a dynamic high-voltage submarine cable. In this example, the cable 2 is shown as an XLPE cable. However, other types of cables, for example a HVDC mass impregnated (MI) cable, may be provided in analogy.

The cable 2 may be used to transfer electric power through alternating current (AC) or direct current (DC). The main extension direction of the cable 2 is indicated by a dash-dotted line with the identifier x.

The cable 2 has a core assembly 4, which may contain a single conductor or multiple conductors. The conductor(s) may be made of copper or aluminum and may be stranded. The core assembly 4 is surrounded by an insulation arrangement 6, which may comprise an insulation layer, such as a high-performance polymer like XLPE (cross-linked polyethylene) or EPR (ethylene propylene rubber). The insulation arrangement 6 may also include at least one semiconducting layer 7 arranged directly on the conductor(s) and/or directly on the insulation layer.

The insulation arrangement 6 is enclosed by a radial water barrier 8. In this exemplary embodiment, the water barrier 8 is made from a longitudinally welded, lead-free metal sheet formed into a tube. As stated above, the term “lead-free” is to be understood as having a lead content below 10 wt.-%, preferably below 2 wt. % based on the total weight of the metal or metal alloy.

The radial water barrier 8 has an outer surface 9. As shown in FIG. 1, the outer surface 9 comprises a radially undulating structure 13 with a pitch p along the longitudinal direction. Here, the pitch p defines the axial distance between repeating elements along the water barrier 8. If the pattern repeats along the water barrier length, the axial pitch is the linear spacing between identical features.

In this example, the pattern is primarily defined by a helical groove 14 running along the longitudinal direction x. The pitch p exemplarily ranges from 5 mm to 150 mm. In the example shown, the pitch p exceeds the diameter of the core assembly 4, but smaller or larger pitches are also possible.

The water barrier 8 is covered by an armor layer 10, which may be made from armor wires. The armor layer 10 is exemplarily covered by an outer sheath 12.

FIG. 2 provides a sectional view of the radial water barrier 8. Here, the water barrier 8 includes a tape layer 17 with a tape 16 helically wound around the insulation arrangement 6. Thus, a plurality of tape windings is created. In this exemplary embodiment, consecutive tape windings are spaced apart from each other, creating gaps 18 between axially consecutive edges of the tape windings.

The radial water barrier 8 includes a metal sheet 11 that is longitudinally welded to form a tube. The metal sheet 11 is in flush contact with the tape layer 17 and has a thickness of exemplarily 0.1 to 0.7 mm. The metal sheet 11 follows the contours of the tape layer 17 and the gaps 18, making the tape contours visible on the outer surface 9. The gaps 18 between the tape windings form a groove 14 with a rounded base. The maximum radial distance between the rounded base and the part of the outer surface 9 overlapping with the tape 16 is defined as the radial depth or amplitude of the geometric pattern 13. According to the invention, the radial water barrier 8 has an amplitude in the range of 0.015 mm to 5 mm.

### REFERENCE NUMERALS

2 Cable
4 Core assembly
6 Insulation arrangement
7 inner semiconducting layer
8 Radial water barrier
9 Outer surface
10 Armoring layer
11 Metal sheet
12 Outer sheath
13 Radial geometric pattern
14 Helical groove
16 Tape
17 Tape layer
18 Gap
p Pitch
x Longitudinal direction

1. A radial water barrier for a power transmission cable,
wherein the water barrier comprises a longitudinally welded lead-free metal sheet formed into a tube having an outer surface,
wherein at least a part of the outer surface has a radially undulating structure with a pitch of at least 2 mm in a longitudinal direction, and
wherein the radially undulating structure has an amplitude in form of a radial depth of the radially undulating structure in the range of 0.015 to 5 mm.

2. The radial water barrier according to claim 1,
wherein the metal sheet comprises copper, a copper alloy, aluminium, an aluminium alloy, or steel.

3. The radial water barrier according to claim 1,
wherein the metal sheet has a thickness in a range of 0.1 to 0.7 mm.

4. The radial water barrier according to claim 1,
wherein the radially undulating structure comprises a corrugation.

5. The radial water barrier according to claim 1,
wherein the radially undulating structure comprises a helical radial protrusion and/or a helical radial indentation.

6. The radial water barrier according to claim 1,
wherein the longitudinal pitch is in a range of 5 mm to 150 mm.

7. The radial water barrier according to claim 1,
wherein the tube has an inner diameter of at least 60 mm.

8. The radial water barrier according to claim 1,
comprising a tape layer having a tape helically wound around an underlying layer of the cable,
wherein consecutive tape windings overlap or are distanced to each other, and
wherein the metal sheet is arranged in substantially flush contact on the tape layer.

9. Method for manufacturing a subsea cable, comprising the steps of:
forming at least one conductor,
applying at least one insulation and/or semiconducting layer, and
forming a radial water barrier around the at least one insulation and/or semiconducting layer by longitudinally welding a lead-free metal sheet formed into a tube having an outer surface,
wherein at least a part of the outer surface has a radially undulating structure with a longitudinal pitch in a longitudinal direction, and
wherein the radially undulating structure has an amplitude in form of a radial depth of the radially undulating structure in the range of 0.015 mm to 5 mm.

10. The method according to claim 9, comprising the step of:
forming a tape layer by helically winding a tape around the at least one insulation and/or semiconducting layer,
wherein consecutive tape windings overlap or are distanced to each other,
wherein the metal sheet is arranged in flush contact on the tape layer,
wherein the radial water barrier is formed on the tape layer, and
wherein the radially undulating structure of the radial water barrier is formed through the tape layer.

11. The method according to claim 9,
wherein the longitudinal pitch is in a range of 5 mm to 150 mm.

12. A dynamic high-voltage submarine cable, comprising:
at least one conductor,
an insulation layer around the at least one conductor,
at least one semiconducting layer, and
a radial water barrier according to claim 1.

13. The cable according to claim 12, comprising:
an armoring layer, and
an outer sheath.
